(19) United States
(12) Patent Application Publication
(10) Pub. No.: US 2026/0153382 A1
(43) Pub. Date: Jun. 4, 2026

(54) MULTIMODE TRANSMISSION MEDIUM OPTICAL PHOTONIC WAVEFRONT SENSOR AND PHOTONIC WAVEFRONT SENSING SYSTEM INCLUDING A TRAINED EXPERT SYSTEM

(71) Applicants: Jeffrey Richard KUHN, Kula, HI (US); Ian Cunnyngham, Honolulu, HI (US); Natalia Arteaga Marrero, San Cristobal de La Laguna (ES); María Auxiliadora Padrón Brito, Santa Cruz de Tenerife (ES)

(72) Inventors: Jeffrey Richard KUHN, Kula, HI (US); Ian Cunnyngham, Honolulu, HI (US); Natalia Arteaga Marrero, San Cristobal de La Laguna (ES); María Auxiliadora Padrón Brito, Santa Cruz de Tenerife (ES)

(21) Appl. No.: 19/304,544

(22) Filed: Aug. 19, 2025

Related U.S. Application Data
(60) Provisional application No. 63/726,446, filed on Nov. 29, 2024.

(51) Int. Cl. G01J 9/02; G01J 9/00

(52) U.S. Cl. CPC G01J 9/02; G01J 2009/002; G01J 2009/0226

(57) ABSTRACT

An expert system is trained to predict wavefront information (e.g., phase(s) and/or amplitude(s)) from a speckle pattern (also referred to as a speckle intensity image) due to the interference created by propagation through a multimode fiber (MMF). Once trained, the expert system allows modal amplitude(s) and/or phase(s) in a light signal applied to a proximal end of a MMF to be detected from the output speckle intensity image at the distal end of the MMF. This system works for broad-band light and does not require restricted symmetry properties of the modal input light.

The present application claims priority benefit to U.S. Provisional Application No. 63/726,446 (referred to as “the '446 provisional” and incorporated herein by reference), filed on Nov. 29, 2024, titled “MULTIMODE FIBER OPTICAL PHOTONIC WAVEFRONT SENSOR AND PHOTONIC WAVEFRONT SENSING SYSTEM INCLUDING A TRAINED EXPERT SYSTEM”, and listing Jeffrey Richard Kuhn as the inventor. The present application (listing Natalia Arteaga Marrero, Ian Cunnyngham, Jeffrey Richard Kuhn, and Maria Auxiliadora Padrón Brito as joint inventors) is not limited to any specific embodiments or any requirements described in the '446 provisional.

### § 1. BACKGROUND OF THE INVENTION § 1.1 Field of the Invention

The present invention concerns receiving and decoding information and/or receiving and sensing information in photonic signals. In particular, the present invention concerns sensing complete information about a light wavefront using photonic and free-space optics, and machine learning techniques to solve the highly non-linear problem of finding incident Electric field information from a complex broad-band optical source.

### § 1.2 BACKGROUND OF THE INVENTION

Light has been used to encode information (e.g., as pulses of light). Light has also been used to transmit information (e.g., over open air, or through an optical fiber such as a multimode optical fiber (MMF)). Light or photons may be captured by sensor (e.g., charge coupled devices or CCDs), often as intensity information. However, it would be useful to be able to sense additional photonic information, such as wavefront information (e.g., phase(s), amplitude(s), etc.), particularly when light intensity information can be lost or obscured (e.g., due to atmospheric conditions for photons traveling in open air) because wavefront information provides information on the imaged object in addition to intensity.

Light from distant celestial objects arrives at Earth as an almost perfect plane wave. However, atmospheric turbulence—in the form of rapidly varying refractive-index inhomogeneities—introduces spatial and temporally varying phase distortions. Adaptive optics (AO) systems attempt to correct these aberrations in real time. In AO systems, a wavefront sensor (WFS) measures the distorted wavefront, and a deformable mirror reshapes itself to cancel out the distortions, restoring an approximation of the original plane wave. (See, e.g., the document, Richard Davies and Markus Kasper, “Adaptive Optics for Astronomy,” Annual Review of Astronomy and Astrophysics, 50(1): 305-351, September 2012 (incorporated herein by reference), and the document, Karen M. Hampson, Raphael Turcotte, Donald T. Miller, Kazuhiro Kurokawa, Jared R. Males, Na Ji, and Martin J. Booth, “Adaptive optics for high-resolution imaging,” Nature Reviews Methods Primers, 1(1):68, October 2021 (incorporated herein by reference).)

Traditional wavefront sensors, such as Shack-Hartmann or Pyramid sensors, measure phase distortions at the pupil plane. Then, they share a different optical path than the science camera, making them susceptible to non-common-path aberrations, and thus limit performance in extreme AO. (See, e.g., the document, P. Martinez, C. Loose, E. Aller Carpentier, and M. Kasper, “Speckle temporal stability in XAO coronagraphic images,” Astronomy & Astrophysics, 541:A136, May 2012 (incorporated herein by reference), and the document, Olivier Guyon, “Extreme Adaptive Optics,” Annual Review of Astronomy and Astrophysics, 56(1):315-355, September 2018 (incorporated herein by reference).) They are also vulnerable to wind-induced vibrations and “petal” effects, which are phase steps introduced by discontinuities between segments in large, segmented primary mirrors. (See, e.g., the document, M. N'Diaye, F. Martinache, N. Jovanovic, J. Lozi, O. Guyon, B. Norris, A. Ceau, and D. Mary, “Calibration of the island effect: Experimental validation of closedloop focal plane wavefront control on Subaru/SCExAO,” Astronomy & Astrophysics, 610:A18, February 2018 (incorporated herein by reference).)

Focal-plane wavefront sensing (FPWFS) circumvents many of these issues by using the same optical path as the science beam and by directly analyzing the focal-plane electric field.

### § 2. SUMMARY OF THE INVENTION

An expert system is trained to predict wavefront information (e.g., phase(s) and/or amplitude(s)) from a speckle pattern (also referred to as a speckle intensity image) due to the interference created by propagation through a multimode fiber (MMF).

Once trained, the expert system allows modal amplitude(s) and/or phase(s) in a light signal applied to a proximal end of a MMF to be detected from the output speckle intensity image at the distal end of the MMF. This system works for broad-band light and does not require restricted symmetry properties of the modal input light.

An example method for light/wavefront sensing includes: (a) receiving a light having a spectral range of interest; (b) focusing the light received onto a first surface of a multimode transmission medium; (c) imaging a speckle pattern from light exiting a second surface of the multimode transmission medium to generate a spectral pattern image; (d) providing the speckle pattern as input to an expert system that has been trained to predict at least one of (A) phase(s) and/or (B) amplitude(s) of light received from a speckle pattern; and (e) generating, using the expert system, at least one of (A) phase(s) and/or (B) amplitude(s) of the light received and focused onto the first surface of the multimode transmission medium.

An example apparatus for light/wavefront sensing includes: (a) a multimode transmission medium; (b) a first optical system configured to receive a light having a spectral range of interest, and focus the light received onto a first surface of the multimode transmission medium; (c) an imaging device; (d) a second optical system configured to focus a speckle pattern from light exiting a second surface of the multimode transmission medium onto an imaging plane of the imaging device; and (e) an expert system that has been trained to predict at least one of (A) phase(s) and/or (B) amplitude(s) of light received from a speckle pattern, the expert system configured to (1) receive a speckle pattern image from the imaging device, and (2) generate at least one of (A) phase(s) and/or (B) amplitude(s) of the light received and focused onto the first surface of the multimode transmission medium.

In some example implementations of the example method and apparatus, the multimode transmission medium is a multimode fiber. In some such example implementations, a length of the multimode fiber is 1 cm or less (e.g., 0.1 cm-1.0 cm). In some implementations of the example method and system, a length of the multimode fiber is selected to preserve modal interference across a spectral range of interest in the light received and focused onto the first surface of the multimode transmission medium. For example, a maximum length (L) of the multimode fiber may be defined by:

$$L ≲ \frac{{λ}^{2}}{Δ λ \cdot Δ {n}_{g}}$$

wherein λ is a central wavelength of the light received and focused onto the first surface of the multimode transmission medium, Δλ is a spectral bandwidth of interest of the light received and focused onto the first surface of the multimode transmission medium, and Δn_{g} is a variation in a group index across modes supported by the multimode fiber.

### § 3. BRIEF DESCRIPTION OF THE DRAWINGS

FIG. 1 illustrates the output speckle intensity for the (1,1) fiber input mode for three different phases.

FIG. 2 is a flow diagram of an example method for training an expert system to generate predicted modal phase(s) and/or amplitude(s) from an input speckle pattern.

FIG. 3 is a flow diagram of an example method for photonic wavefront sensing.

FIG. 4 is an example system for training an expert system to generate predicted modal phase(s) and/or amplitude(s) from an input speckle pattern.

FIG. 5 is an example system for photonic wavefront sensing.

FIG. 6 illustrates the modeling of a pupil that provides input to the MMF with a set of 49 (1,p) fiber modes.

FIG. 7 shows the simulation results for monochromatic illumination and propagation through a step-index MMF.

FIG. 8 compares the MMF output patterns for different fiber lengths, confirming the degradation of sensitivity with longer fibers under broadband illumination.

FIG. 9 illustrates intensity patterns at the output of a MMF resulting under four different conditions, varying both the fiber length and the spectral bandwidth of the input light.

FIGS. 10 and 11 are tables including network performance data under varying atmospheric conditions in terms of the average validation loss for non-OPD-limited and OPD-limited datasets (each with 56,000 samples), respectively.

FIGS. 12 and 13 are tables including network performance data under varying atmospheric conditions in terms of the average validation loss for non-OPD-limited and OPD-limited datasets (each with 120,000 samples), respectively.

FIG. 14 compares the predicted and the original OPD, for a CNN trained on the non-OPD limited dataset, under varying atmosphere conditions.

FIG. 15 illustrates an example telescope fitted with additional components of an example system consistent with the present description.

FIG. 16 is a schematic diagram of an experimental setup used to evaluate certain aspects of an example system consistent with the present description.

### § 4. DETAILED DESCRIPTION

The present disclosure may involve novel methods, apparatus, message formats, and/or data structures to (A) train an expert system to predict wavefront information (e.g., phase(s) and/or amplitude(s)) from a speckle pattern due to the interference created by propagation through a multimode transmission medium (e.g., an MMF), and/or (B) detect modal amplitude(s) and/or phase(s) in a light signal applied to a proximal end of a multimode transmission medium (e.g., MMF) using the output speckle intensity image at the distal end of the MMF and a trained expert system. The following description is presented to enable one skilled in the art to make and use the described embodiments, and is provided in the context of particular applications and their requirements. Thus, the following description of example embodiments provides illustration and description, but is not intended to be exhaustive or to limit the present disclosure to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present description unless explicitly described as such. Also, as used herein, the article “a” is intended to include one or more items. Where only one item is intended, the term “one” or similar language is used. Thus, the present disclosure is not intended to be limited to the embodiments shown and the inventors regard their invention as any patentable subject matter described.

### § 4.1 Theory of Operation

§ 4.1.1 Electric Field as a Superposition of Modes that Propagate Through a Mmf

In optical fibers, the electric field can be expressed as a superposition of the modes that propagate through the fiber. Each mode can be characterized by its amplitude and phase, allowing one to represent the total electric field as the sum of the individual modes. For a fiber with N modes, the total electric field E (x,y,z,t) can be represented as:

$$E ( x , y , z , t ) = {\sum }_{n = 1}^{N} {A}_{n} {ψ}_{n} ( x , y ) {e}^{i ( {k}_{n} z - {ω}_{n} t + {ϕ}_{n} )}$$

where:
Aₙ is the amplitude of the n-th mode;
ψₙ (x,y) is the spatial field distribution of the n-th mode (the mode profile);
kₙ is the wave vector associated with the n-th mode, related to the effective index of the mode;
ωₙ is the angular frequency of the n-th mode;
φₙ is the relative phase of a given mode at the fiber input
z is the propagation direction along the fiber; and
t is time

The amplitude Aₙ can vary based on the input conditions and the properties of the fiber, such as its loss and dispersion characteristics. The phase term e^{i(k}^{ₙ}^{z-ω}^{ₙ}^{t+φ}^{ₙ}) reflects both the spatial and temporal evolution of each mode. The relative phase difference between modes affects the interference pattern of the combined electric field.

Due to the linearity of Maxwell's equations, the superposition of the modes results in interference effects. The total electric field will exhibit characteristics based on the constructive or destructive interference of the modes, influenced by their relative amplitudes and phases. As an example, consider a simple case with two modes. In this simple example, the electric field can be expressed as:

$$E ( x , y , z , t ) = {A}_{1} {ψ}_{1} ( x , y ) {e}^{i ( {k}_{1} z - {ω}_{1} t + {ϕ}_{1} )} + {A}_{2} {ψ}_{2} ( x , y ) {e}^{i ( {k}_{2} z - {ω}_{2} t + {ϕ}_{2} )}$$

§ 4.1.1.1 Theoretical Model of Wavefront Sensing with a Multimode Fiber

For a monochromatic input electric field, the electric field at the output of the multimode fiber can be expressed as

$${u}_{out} = {BTPFu}_{in} , \qquad ( 1 )$$

where uᵢₙ is the electric field at the pupil plane, represented in the pupil-plane grid basis. F is the Franhoufer propagator (which is proportional to a Fourier transform), and, when applied to uᵢₙ, gives us the electric field at the focal plane. This is then represented in the focal-plane grid basis. P is a projection matrix that projects the electric field at the focal plane onto the guided modes of the multimode fiber. In step-index fibers that are radially symmetric and have a very small core-cladding index difference, each guided mode can be treated as approximately linearly polarized, with field profiles separable into simple radial and azimuthal functions. These are known as the LP modes, and they form an orthogonal basis. The output is then a vector of n coefficients that represent the electric field at the focal plane written in the LP modes basis, where n is the number of guided modes in the multimode fiber. T is the propagation matrix that gives us the electric field at the end of the multimode fiber:

$$T = [ \begin{matrix}{e}^{i β 1 z} & … & 0 \\ ⋮ & ⋱ & ⋮ \\ 0 & … & {e}^{i β 1 z}\end{matrix} ] ,$$

where βᵢ is the propagation constant of the i^{th} LP mode. The result of this operation is a vector of n coefficients that represents the electric field at the end of the multimode fiber, written in the basis of the fiber modes. Finally, B is the back-projection matrix, which writes the final electric field back in the focal-plane grid basis. In the simplest case of a square and unitary matrix, B=P^{†}.

If we assume phase-only aberrations, the input electric field can be written as

$${u}_{i n} = t cos ϕ + i \underline{t} \cdot sin ϕ , \qquad ( 2 )$$

where t is the pupil transmission (real), and φ is the phase aberration. Then:

$${u}_{out} = BTP F ( t \cdot cos ϕ + i \underline{t} \cdot sin ϕ ) \qquad ( 3 )$$

If we call a=F{t·cos φ} and b=F{t·sin φ}, then:

$${u}_{out} ∝ B T P ( a + i b ) = B T P a + i B T P b \qquad ( 4 )$$

If φ is even, φ(−x, −y)=φ(x, y), then cos (φ(−x, −y))=cos (φ(x, y)) is also even. Therefore, since a Fourier transform of a real and even function is also even and real, a is real (and even). Similarly, if φ is even, sin (φ(−x, −y))=sin (φ(x, y)) is also even. Then, b is real (and even).

The projection matrix P projects these vectors onto the basis formed by the LP modes of the multimode fiber, which are real-valued and can be both even and odd functions. In general, the coefficients of this projection can be complex numbers but, since both a and b are real values, the coefficients must be real as well. This means that both Pa and Pb are real.

However, TPa isn't real, but it gets a general phase term given by e^{iβiz} that depends on the length of the fiber z. If we measure the intensity in the fiber mode basis, as in the case of a mode-selective photonic lantern, it results in an intrinsic sign ambiguity of even phase distributions. (See, e.g., the document, Jonathan Lin, Michael P. Fitzgerald, Yinzi Xin, Olivier Guyon, Sergio Leon-Saval, Barnaby Norris, and Nemanja Jovanovic, “Focal-plane wavefront sensing with photonic lanterns: theoretical framework,” Journal of the Optical Society of America B, 39(10):2643, October 2022 (incorporated herein by reference).)

However, we measure the output intensity in the basis of the focal grid, not the fiber modes. Representing the focal grid basis in cartesian coordinates (x, y), the output electric field will be given by a linear superposition of the fiber modes:

$${u}_{out} ( x , y ) ∝ {\sum }_{i = 1}^{n} {A}_{i} {e}^{i {β}_{i} z} L {P}_{i} ( x , y ) + i {\sum }_{j = 1}^{n} {B}_{j} {e}^{i {β}_{i} z} {LP}_{j} ( x , y ) , \qquad ( 5 )$$

where Aᵢ are the real-valued mode coefficients obtained when projecting a onto the fiber modes basis, Bⱼ are the real-valued mode coefficients obtained when projecting b onto the fiber modes basis, LPᵢ (x, y) is the i^{th} fiber mode profile in the focal grid basis, and LPⱼ (x, y) is the j^{th} fiber mode profile in the focal grid basis. We can see that, in this case, uₒᵤₜ is a vector whose elements are linear combinations of complex quantities. Therefore, the output intensity is given by:

$${\vert {u}_{out} ( x , y ) \vert}^{2} ∝ {\sum }_{i} ( {A}_{i}^{2} + {B}_{i}^{2} ) L {P}_{i}^{2} ( x , y ) + 2 {\sum }_{i < j} ( {A}_{i} {A}_{j} + {B}_{i} {B}_{j} ) {e}^{( {β}_{i} - {β}_{j} ) z} L {P}_{i} ( x , y ) L {P}_{j} ( x , y ) - 2 {\sum }_{i < j} ( {B}_{i} {A}_{j} + {A}_{i} {B}_{j} ) {e}^{( {β}_{i} - {β}_{j} ) z} L {P}_{i} ( x , y ) L {P}_{j} ( x , y ) . \qquad ( 6 )$$

The first term corresponds to the incoherent sum of intensities from each mode. The second and third terms contain the interference arising from the relative phases of different modes. These interference terms have been split in two, the third term containing the cross-terms between real and imaginary part. This last term changes its sign for positive versus negative even phases at the input. Therefore, as long as the third term is different from zero, the sign ambiguity is broken.

### § 4.1.2 Speckle Pattern Due to Superposition of Modes

Electric field modes in multimode fibers refer to the various pathways that light can take through the fiber, each with unique characteristics. The output speckle intensity is a result of the interference of these modes at the fiber's end, leading to complex intensity patterns that can vary over time and space, influenced by several external and internal factors (including, for example, the geometry of the fiber, the wavelength of the light, and the refractive indices of the core and cladding materials).

A multimode fiber supports multiple propagation modes, each characterized by a specific electric field distribution across the fiber's cross-section. These modes can be categorized as either guided modes (which propagate along the fiber) or leaky modes (which do not). Each mode has a unique mode field diameter, which describes the effective area over which the light is confined in the core. The effective index of refraction for each mode can also vary, leading to differences in how quickly each mode travels. As light travels through the fiber, different modes can interfere with each other, causing variations in the electric field distribution. Further, coupling between modes can occur due to imperfections, bends, or changes in the fiber, leading to energy exchange among modes.

When light exits a multimode fiber, the interference of the different modes creates a speckle pattern, which is a granular intensity distribution. This pattern results from the coherent superposition of light waves emitted by the various modes, each having a different phase and amplitude. The intensity is in general not a linear function of the input modes as the intensity is I∝E².

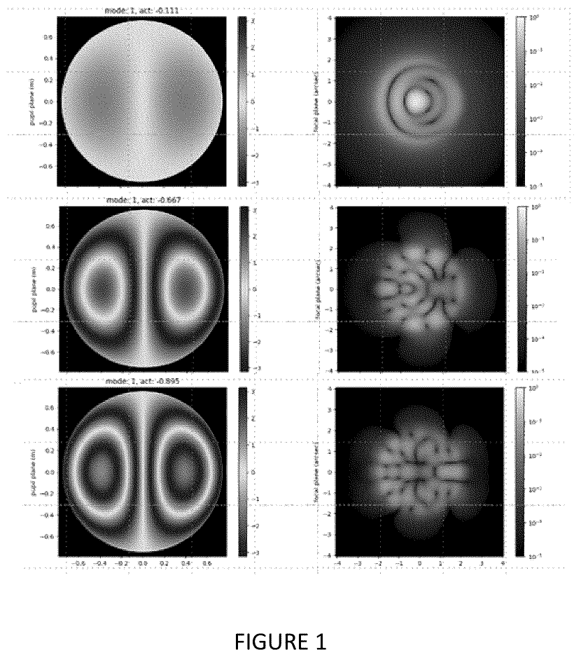

The output intensity created by multimode propagation through the MMF is spatially and temporally complex, and the extraction of individual mode amplitudes and phases from the speckle “noise” output is a non-linear problem. In FIG. 1, the left-side panels show the electric field of a (1,1) mode at the input side of a MMF. As the output speckle complexity on the right-side panels of FIG. 1 suggests, the present inventors heave recognized that the speckle pattern spatial diversity could be well suited to machine learning, particularly convolutional neural networks. This is, in fact, the case. Despite the non-linear complexity of this problem, artificial intelligence (AI) and supervised machine learning solutions can be used with image-domain speckle information as a tool for extracting electric field information from the incoming wavefront.

### § 4.1.3 Impact of Modal Dispersion and Coherence Time

The previous theoretical analysis assumed a monochromatic light source. However, when broadband light is coupled into a multimode fiber (MMF), the situation changes because the MMF transfer matrix is highly wavelength-dependent. The propagation constants of each mode vary significantly with wavelength—even if the change in refractive index within this range is negligible—and the number of supported modes may also change. When integrated over a broad spectral range, the phase differences between the modes βi-βⱼ vary strongly with wavelength. Then, providing a sufficiently long fiber, the interference term of equation (6) averages to zero. However, for small z and narrow bandwidth, the accumulated phase difference (βi-βⱼ) z is small. In this case, the interference term does not average to zero and the sign ambiguity can still be broken. In order to extract the maximum length that allows us to see modal interference for a given light bandwidth, let us introduce the concept of “modal dispersion.”

Modal dispersion arises because different modes propagate through the fiber at different group velocities. As a result, light propagating through different modes arrives at the fiber output at different times. If the time delay exceeds the coherence time of the light, interference between modes is lost, and the resulting intensity pattern at the output is simply an incoherent sum of individual modal intensities. In contrast, for an ideal monochromatic source, which has an infinite coherence time, interference is always present regardless of fiber length.

The time delay between two modes, defined as the difference in propagation times over a fiber of length L, is given by:

$$Δ t = \frac{L}{{v}_{g , 1}} - \frac{L}{{v}_{g , 2}} \qquad ( 7 )$$

where v_{g,1} and v_{g,2} are the group velocities of modes 1 and 2, respectively. The group velocity, in turn, is related to the group index n_{g} by v_{g}=c/n_{g}, where c is the speed of light in vacuum.

The coherence time of a broadband source can be approximated, under the assumption of a narrowband source, with a Gaussian-like spectral profile, and no significant dispersion effects, as:

$${τ}_{c} \approx \frac{{λ}^{2}}{c \cdot Δλ} \qquad ( 8 )$$

where λ is the central wavelength of the source and Δλ is its spectral bandwidth. For modal interference to be observable, the fiber length must satisfy:

$${L}_{∼}^{<} \frac{{λ}^{2}}{Δλ \cdot Δ {n}_{g}} \qquad ( 9 )$$

where Δn_{g} is the variation in the group index across the supported modes, which is given by:

$${n}_{g} = n ( ω ) + ω \frac{d n}{d ω} \qquad ( 10 )$$

The dependence of the refractive index with the wavelength is not a straightforward relationship, but can be approximated by using known analytical solutions.

For a typical step-index fiber the group index varies within the range 1.4755<n_{g}<1.4855 at λ=1 μm. Considering a broadband source with a central wavelength of λ=1 μm and a spectral bandwidth of Δλ=10 nm, the maximum fiber length that allows modal interference is approximately 1 cm.

The previous analysis gives a maximum length in order to observe mode interference. However, there is also a minimum length that allows us to observe interference patterns at the output.

As light travels to the fiber, modes with different propagation constants β gradually get out of phase leading to interference. For the simplest case of two modes, a monochromatic source, and ideal conditions, the interference pattern at the output of the fiber is a periodic function of the fiber length. The wavelength associated to this beating signal is:

$${λ}_{beat} = \frac{2 π}{\vert {β}_{1} - {β}_{2} \vert} \qquad ( 11 )$$

where the subindices 1 and 2 refer to the two different modes. Therefore, the minimum length of the fiber should be of the order of:

$${λ}_{beat}^{max} = \frac{2 π}{\vert \frac{2 π {n}_{c l a d}}{λ} - \frac{2 π {n}_{c o r e}}{λ} \vert} = \frac{λ}{{n}_{c o r e} - {n}_{c l a d}} , \qquad ( 12 )$$

where we took into account that 2πn_{clad}/Δ<β<2πn_{core}/λ.

For common parameters such as n_{core}=1.464, n_{clad}=1.450, and λ=1 μm, the length of the fiber should be L≥100 μm.

### § 4.2 Example Methods for Training and Using an Expert System for Light/Photon Wavefront Sensing

### § 4.2.1 Example Method(s) for Training an Expert System to Generate Predicted Modal Phase(s) and/or Amplitudes from an Input Speckle Pattern

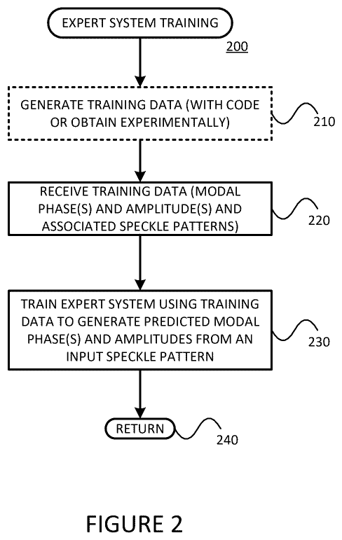

FIG. 2 is a flow diagram of an example method 200 for training an expert system to generate predicted modal phase(s) and/or amplitude(s) from an input speckle pattern. As shown, training data may be generated (e.g., with code, or obtained experimentally). (Block 210) Alternatively, existing training data may be used instead, or in addition. The training data (as modal phase(s) and amplitude(s) and associated speckle patterns) is received (Block 220) and an expert system (e.g., a convolutional neural network) is trained using the training data (Block 230). The method 200 is then left. (Node 240)

### § 4.2.2 Example Method(S) for Using an Expert System for Light/Photon Wavefront Sensing

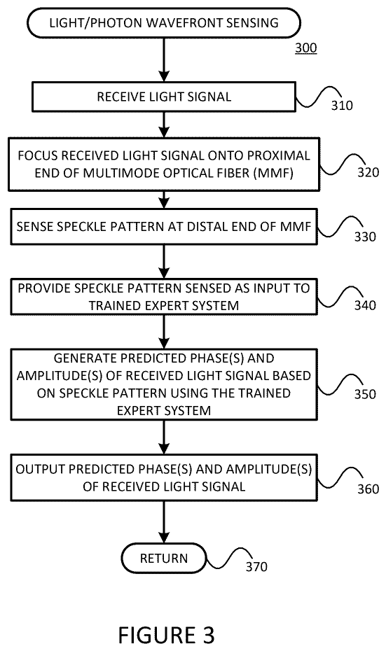

FIG. 3 is a flow diagram of an example method 300 for light/wavefront sensing using a trained expert system. A light signal is received (Block 310) and focused onto the proximal end of an MMF (Block 320). A resulting speckle pattern is observed or sensed at the distal end of the MMF (Block 330) and provided as input to the trained expert system (Block 340). The trained expert system then generates predicted phase(s) and/or amplitude(s) of the received light signal, from the speckle pattern (Block 350). These predicted phase(s) and/or amplitude(s) are then output (Block 360) before the example method 300 is left (Node 370).

### § 4.3 Example Systems for Training and Using an Expert System for Light/Photon Wavefront Sensing

### § 4.3.1 Example System(S) for Training an Expert System to Generate Predicted Modal Phase(S) and/or Amplitudes from an Input Speckle Pattern

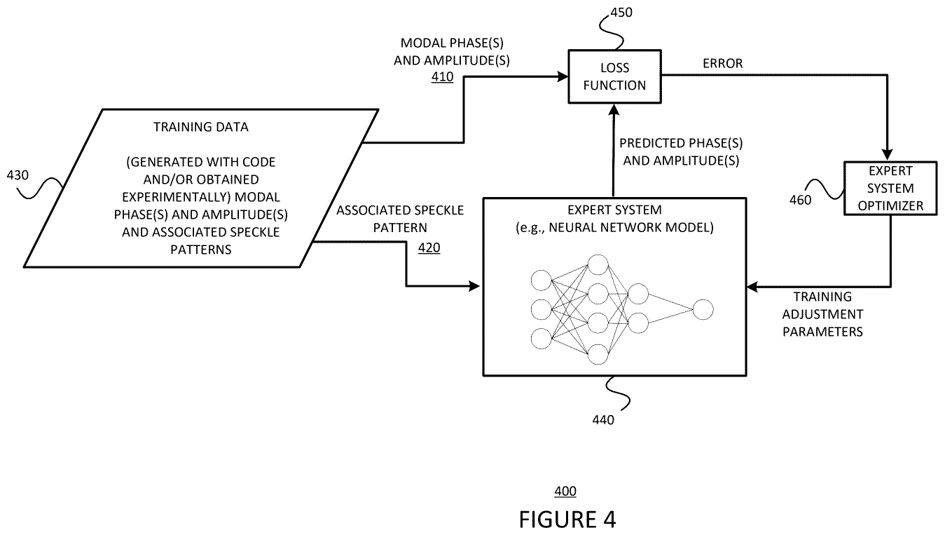

FIG. 4 is an example system 400 for training an expert system 440 to generate predicted modal phase(s) and/or amplitude(s) from an input speckle pattern. The training data 430 (Recall 220) includes sets of modal phase(s) and amplitude(s) 410 and an associated speckle pattern 420. The expert system 440 outputs predicted phase(s) and amplitude(s) given an input speckle pattern. A loss function 450 and expert system optimizer 460 is used to adjust parameters (e.g., neuron weights and/or connections) of the expert system 440.

### § 4.3.2 Example System(S) for Using a Trained Expert System for Light/Photon Wavefront Sensing

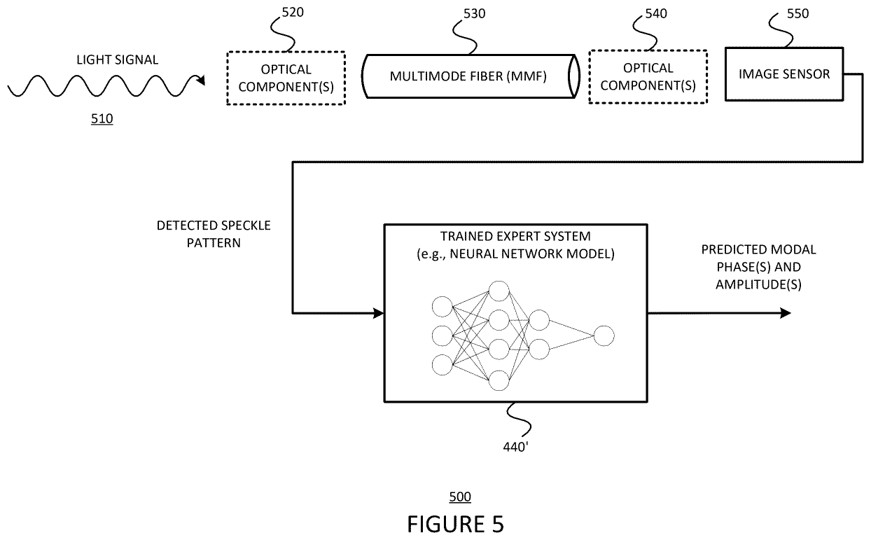

FIG. 5 is an example system 500 for light/wavefront sensing. The system 500 may include optical component(s) 520/540, an MMF 530, an image sensor 550, and a trained expert system 440′. In operation, a light signal 510 is focused, via optical component(s) (e.g., a lens system that places an image or pupil of a larger telescope system) 520 onto a proximal end of the MMF 530. A speckle pattern at the distal end of the MMF 530 is focused, via optical component(s) 540, onto an image sensor 550 which senses the speckle pattern. The sensed or detected speckle pattern is then provided as an input to the trained expert system 440′, which outputs predicted modal phase(s) and amplitude(s) of the light signal 510.

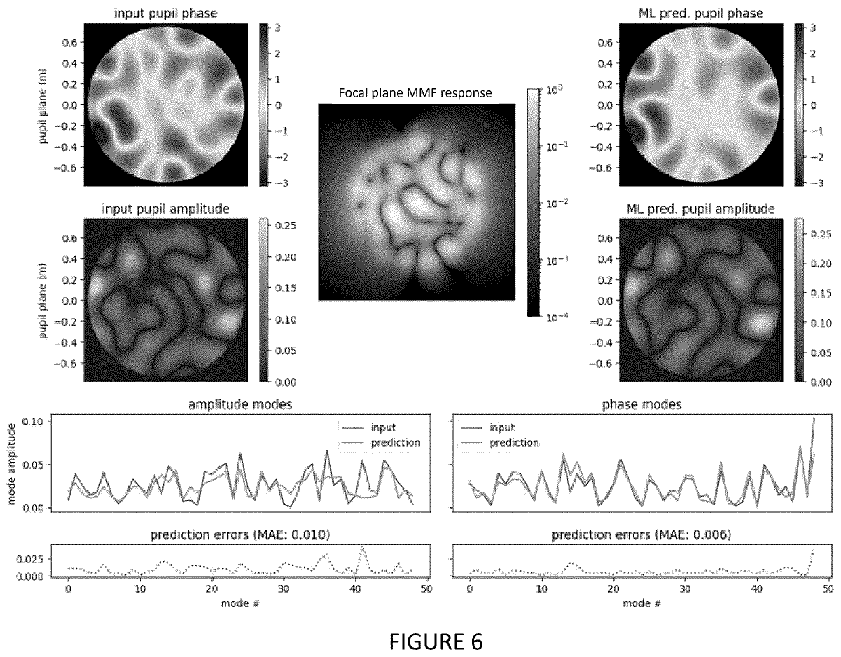

Referring back to 210, training data may be generated as follows. The primary modeling tool in one example implementation is the Python code, HCIPy: High Contrast Imaging for Python. (See, github.com/ehpor/hcipy, available online.) This code is used to create MMF electric field modes and the output speckle intensity shown in FIGS. 1 and 6. FIG. 1 illustrates the output speckle intensity for the (1,1) fiber input mode for three different phases. The three vertical bi-panels show the mode at three different temporal phase values. Right side panels show the corresponding output speckle intensity pattern. Note how the phase is distinctly encoded in the spatial distribution of each output speckle intensity pattern. The present inventorss observe that the output speckle images in the three panels are remarkably distinct and quite clearly encode mode phase information.

### § 4.3.2.1 Example Mmf Lengths

As described above, example implementations may use a MMF having a “short” length. In some example implementation, this short length is up to 1 cm. However, fabricating a shorter length MMF may be difficult, or at least more expensive. Therefore, in some example implementations, the length to the MMF fiber is between 0.1 and 1.0 cm. As should be appreciated from the theoretical discussion above, the fiber has to be short enough so that modal interference is preserved across the spectral bandwidth (also referred to as “the spectral range of interest”). The spectral range of interest may be defined by the central wavelength (λ) of the source, and its spectral bandwidth (Δλ). In other words, the length of the MMF should be chosen so that the coherence length of the light exceeds the differential group delay between modes within the fiber in order to ensure that interference patterns do not average out. (Recall equation (9) above.) Although the minimum length might be limited, practically, by issues and challenges related to fabricating very short MMFs, most example implementations will be longer than a minimum length defined by equation (12) above.

### § 4.3.2.2 Alternative Multimode Transmission Media

Although some example implementations were described in the context of MMFs, other (e.g., glass-based) multimode transmission media can be used instead, provided that the different propagation constants of the different wavelengths in the spectral range of interest cause an observable interference pattern (e.g., an observable speckle pattern) from which phase and/or amplitude can be derived (e.g., when provided to a trained expert system). As one example, a small glass substrate may support the propagation of different modes within a spectral range of interest. For example, a glass transmission medium with a non-circular cross-section may be used. Note that it might be desirable in certain applications to support a broad spectral range of interest (e.g., to receive more light). The multimode transmission medium will have a first surface for receiving light (e.g., the proximal end of a MMF), and a second surface for emitting light with a speckle pattern (e.g., the distal end of a MMF).

### § 4.4 Experimental Results

FIG. 6 illustrates the modeling of a pupil that provides input to the MMF with a set of 49 (1,p) fiber modes. In these calculations only positive mode amplitudes are considered (for symmetry reasons) but the expert (machine learning) model separately solves for the amplitude and phase of each electric field mode in the fiber. The supervised convolutional network training set (Recall, e.g., 430 of FIG. 4.) used about ten million pairs of arbitrary amplitude electric field and output speckle intensity information. Thea supervised machine learning solution illustrates an arbitrary light source described by a randomly chosen phase and amplitude superposition of 49 fiber modes. The two left panels show the input local electric field phase and amplitude at the pupil of the instrument. The resulting fiber output intensity speckle pattern from this field (which is the input to the ML inversion) is shown at the top middle panel of FIG. 6. The corresponding ML solution for the deduced input E-field phase and amplitude is shown in the right image panels. The agreement is good. The graphs in FIG. 6 show the ML-derived phase and amplitude solution and input phase and amplitude (overplotted) versus mode number.

### § 4.4.1 Experimental (Simulation) Results Showing the Effect of Mmf Length on Sign Ambiguity

### § 4.4.1.1 Break of Sign Degeneracy of Even Phases

In optical systems with a single circular aperture, phase distributions that are even in the pupil—such as defocus or astigmatism—produce identical intensity patterns at the focal plane when applied with opposite signs. This sign ambiguity is a known limitation for existing wavefront sensing, particularly when phase retrieval relies on intensity-only measurements at the focal yet highly sensitive wavefront plane.

A short multimode fiber (MMF) can serve as a simple sensor capable of resolving this ambiguity, even under broadband illumination. The key lies in keeping the fiber short enough so that modal interference is preserved across the spectral bandwidth. In other words, the length of the MMF should be chosen so that the coherence length of the light exceeds the differential group delay between modes within the fiber. This ensures that interference patterns do not average out, allowing the MMF to break the sign degeneracy of even phases. A theoretical model supporting this condition was described above, in § 4.1.1.1.

To illustrate the resolution of the sign ambiguity, we selected defocus as a representative even Zernike polynomial. The conclusions drawn from this example extend to other even modes.

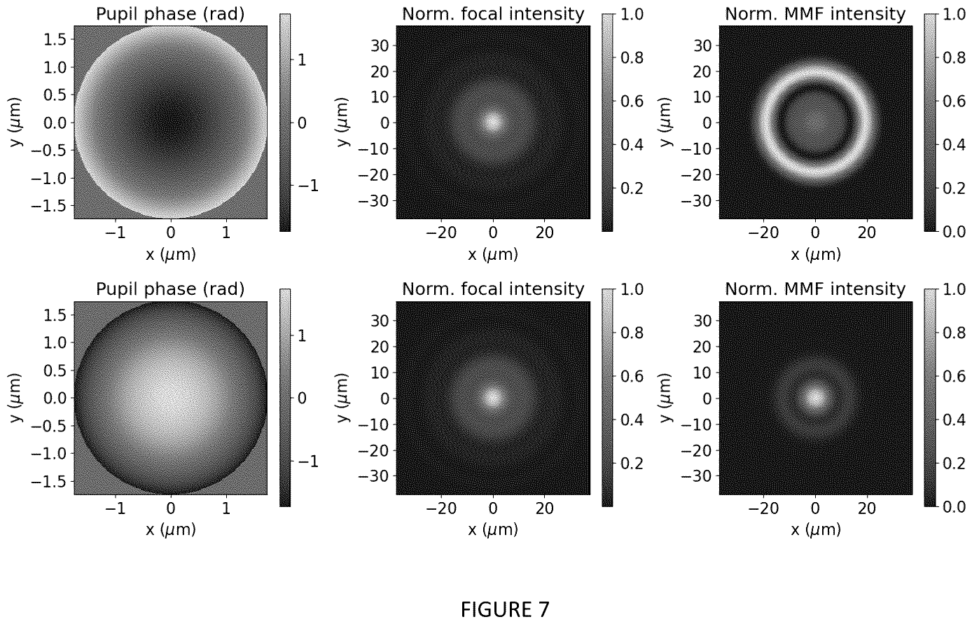

FIG. 7 shows simulation results for monochromatic illumination at λ=1 μm and propagation through a step-index MMF with a core radius of 25 μm and a NA of 0.1, resulting in 123 guided modes for the selected wavelength. The input phase distributions at the pupil plane (left column) correspond to positive (top row) and negative (bottom row) defocus. As expected, the resulting focal plane intensities (middle column) are identical. However, after propagation through a MMF, the output intensity patterns (right column) differ clearly, indicating that the MMF is sensitive to the sign of the input phase. In the monochromatic case, this effect persists for MMFs of any length, since the infinite coherence length ensures stable interference between the guided modes.

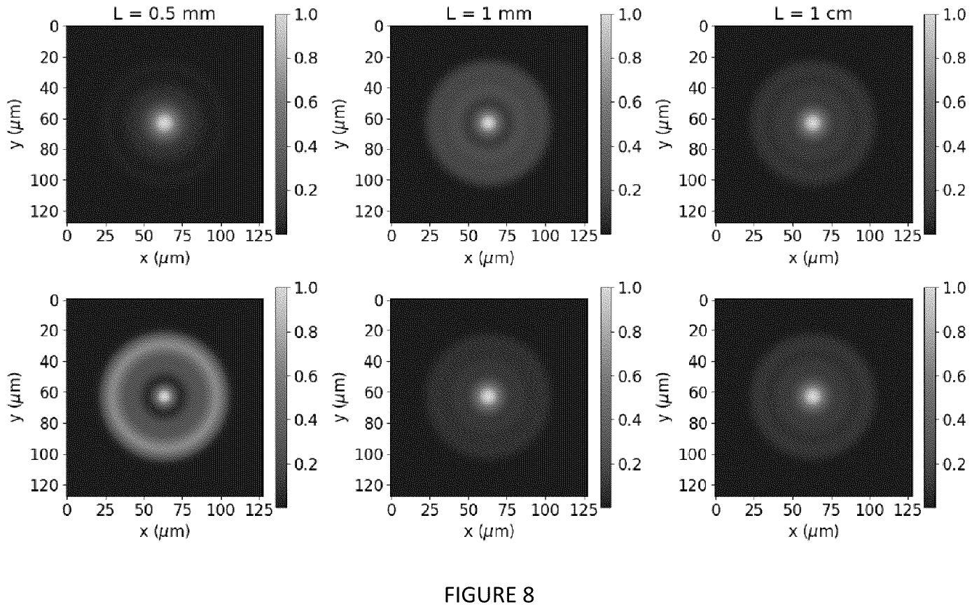

As noted above, when using broadband light, the MMF's ability to break the sign degeneracy depends critically on its length. As derived from the theoretical model of § 4.1.1.1, the multimode interference terms diminish with increasing fiber length due to chromatic averaging. This effect is shown in FIG. 8, where we compare the MMF output patterns for different fiber lengths using a 100 nm bandwidth centered at λ=1 μm. For the shortest fiber (L=0.5 mm), the output intensity is still sensitive to the sign of the input phase. However, as the fiber length increases to 1 cm, the output patterns become nearly indistinguishable, confirming the degradation of sensitivity with longer fibers under broadband illumination.

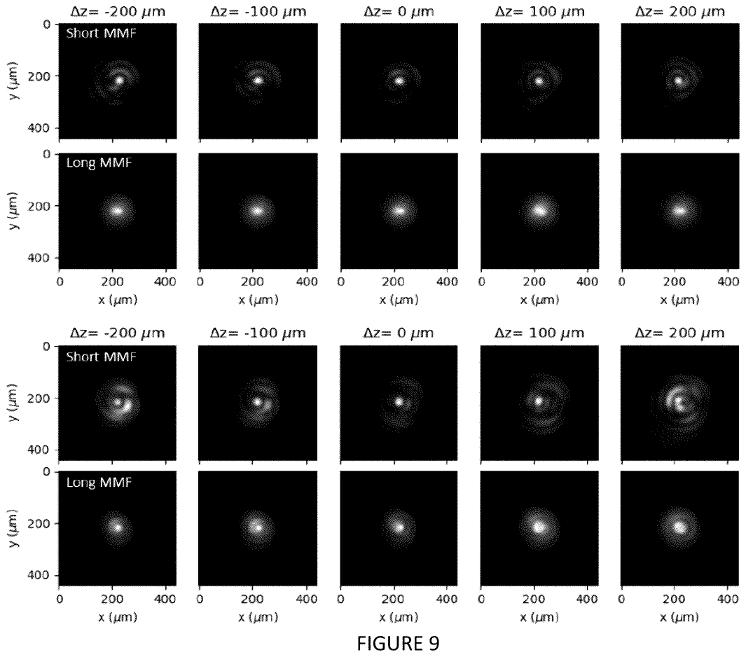

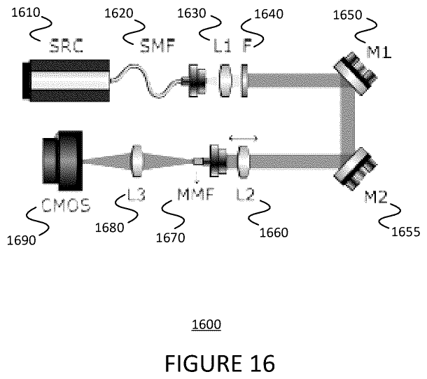

We validated our simulation results with a laboratory experiment. To generate an even phase distribution resembling defocus at the pupil, we shifted the focusing lens (See, e.g., L2 in FIG. 16, discussed below) slightly forward and backward from its optimal position. The resulting intensity patterns at the output of a MMF were recorded under four different conditions, varying both the fiber length and the spectral bandwidth of the input light, as shown in FIG. 9. We used a step-index MMF with a core radius of 50 μm and a NA of 0.22, what correspond to approximately 2100-2400 guided modes within the spectral range used in our experiments.

The top two rows of FIG. 9 correspond to a broadband white-light source filtered with a 10 nm band-pass filter centered at 1 μm. The first row shows the MMF output for a short fiber (approximately 1 cm in length), while the second row shows the output for a long fiber (approximately 1 m).

The bottom two rows display results for a laser source at 1064 nm. As before, the third row corresponds to the short fiber (approximately 1 cm in length) and the fourth to the long one (approximately 1 m).

For the short fiber cases (first and third rows), the MMF output patterns clearly differ when the lens is displaced to simulate positive or negative defocus, confirming the sensor's ability to distinguish between even phase distributions of opposite sign. Additionally, the interference features are more distinct and structured with the short fiber, indicating effective modal interference. In contrast, for the broadband source and long fiber (second row), the output intensity becomes nearly homogeneous along the fiber core, showing little to no variation with the lens position. This confirms that the MMF loses sensitivity to the sign of the input phase when the delay between fiber modes exceeds the coherence length of the light.

### § 4.4.2 Experimental (Simulation) Results Showing the Effect of Learning Sample Number of Phase Reconstructions

### § 4.4.2.1 Phase Reconstruction Via Deep Learning § 4.4.2.1.1 100 Nm Bandwidth (56,000 Samples)

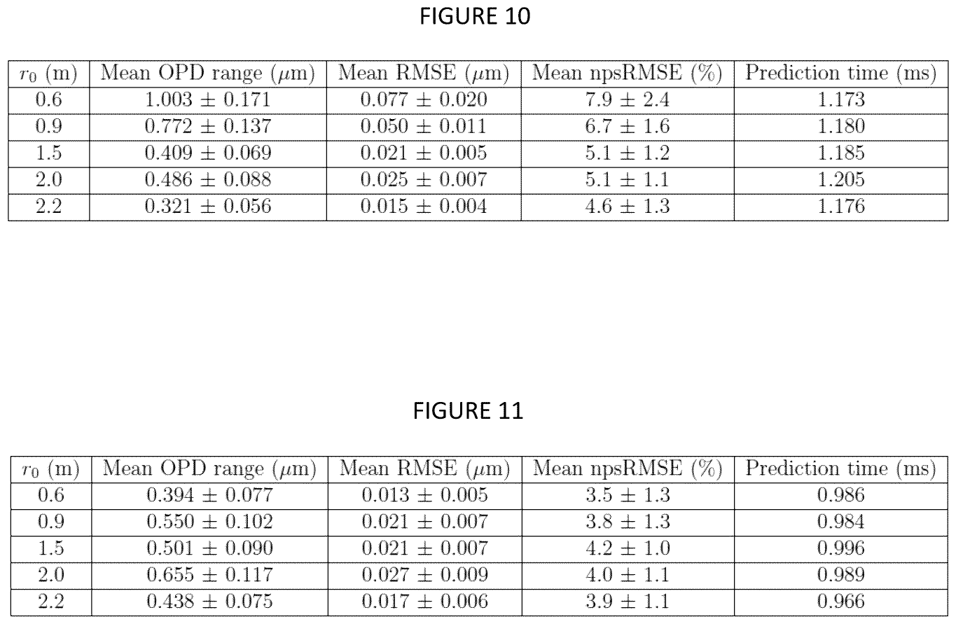

Training the network on both the non- and OPD-limited datasets took approximately one hour on a system equipped with 72 CPU cores and an NVIDIA A100-SXM4-80 GB GPU. The network's performance was evaluated under varying atmospheric conditions in terms of the average validation loss during the training process. In addition, the mean and standard deviation RMSE were estimated across samples (multioutput). For reference, the average inference time required per sample was also extracted. These results are summarized in Table 1 of FIG. 10 and Table 2 of FIG. 11 for the non-OPD-limited and OPD-limited datasets, respectively.

### § 4.4.2.1.2 100 Nm Bandwidth (120,000 Samples)

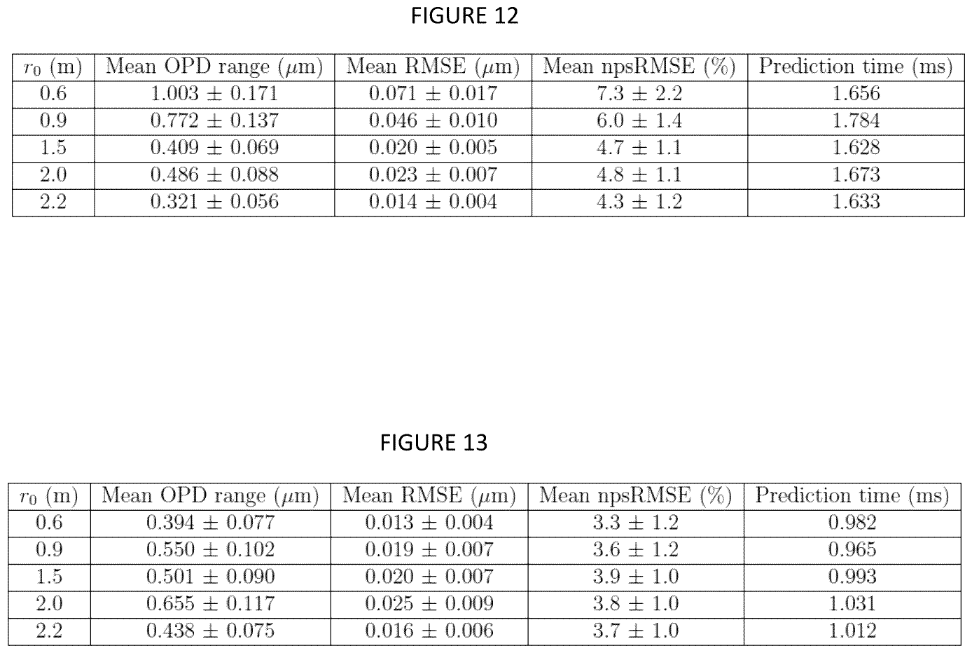

The CNN was trained in approximately two hours for both, the non-OPD-limited and OPD-limited datasets. The training results for these datasets are shown in Table 3 of FIG. 12 (for the non-OPD-limited dataset) and Table 4 of FIG. 13 (for the OPD-limited dataset).

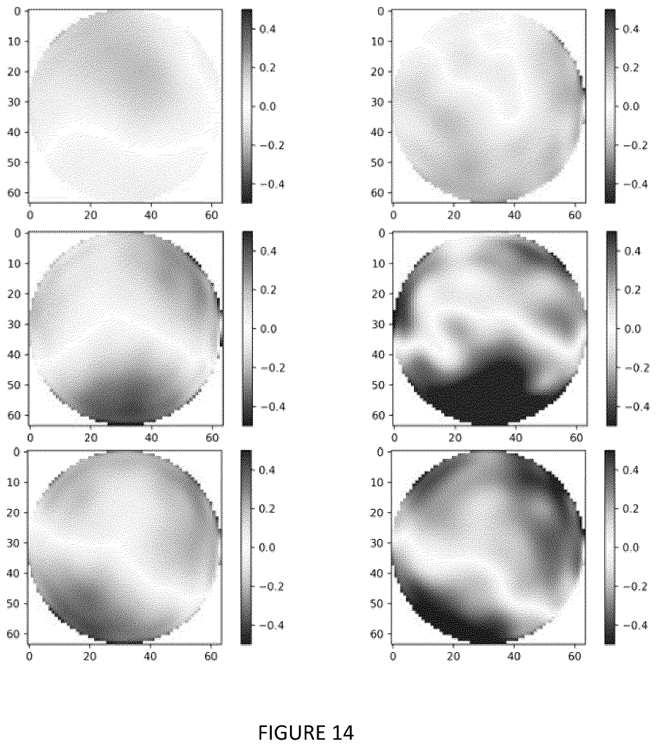

FIG. 14 illustrates the comparison between the predicted and the original OPD, for the CNN trained on the non-OPD-limited dataset, under varying atmosphere conditions. More specifically, the predicted images (on left) are compared with the original OPD (on right) for an atmosphere characterized by a Fried's parameter of 0.9 (lower row), 1.5 (intermediate row) and 2.0 m (upper row).

### § 4.4.3 Discussion of Results

We have demonstrated that a very short multimode fiber (MMF) can serve as a compact, low-cost focal-plane wavefront sensor capable of resolving the sign ambiguity of even phase modes under both monochromatic and broadband illumination. Using convolutional neural networks (CNNs) trained on pairs of known wavefronts and MMF output intensities, we achieved root-mean-square (RMS) reconstruction errors as low as 0.013±0.004 μm and prediction times on the order of milliseconds (e.g., less than 2.0 ms) well within the requirements for real-time adaptive optics control.

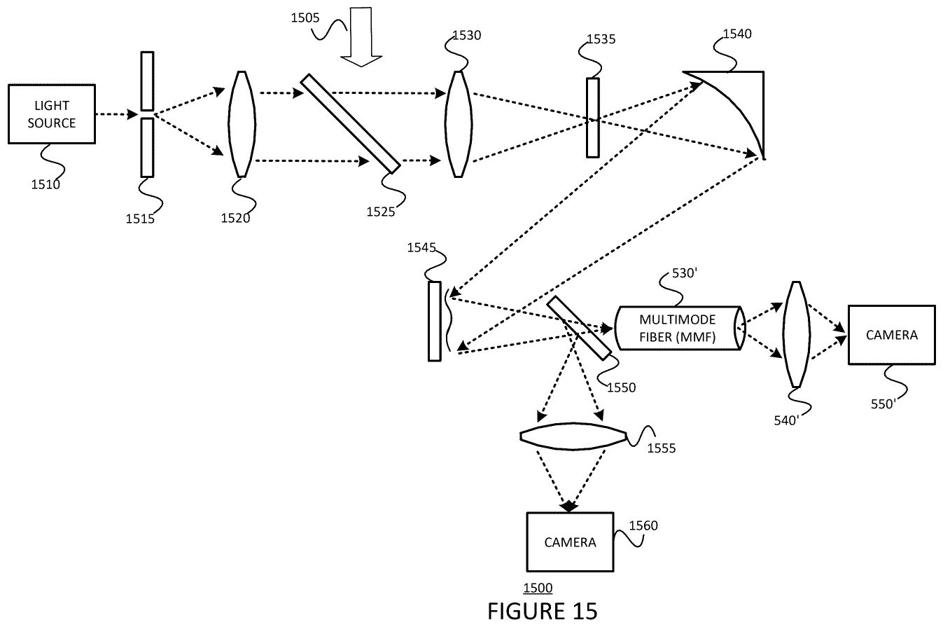

Implementation on a working telescope will require addressing a few practical issues. First, the calibration should (e.g., must) remain stable over hours or entire nights, despite temperature fluctuations and changing gravity vectors. Second, the MMF-CNN pipeline should (e.g., must) be integrated into closed-loop deformable-mirror control. The present inventors expect that field tests on existing telescopes will demonstrate performance and robustness in real working conditions. FIG. 15 illustrates an example telescope 1500 fitted with additional components corresponding to 530, 540 and 550 of FIG. 5. The example telescope receives light 1505 at a beam splitter 1525, which combines this light 1505 with light from a light source 1510, passing through an image mask 1515 and lens 1520. The combined light then passes through lens 1530 and filter 1535 to an off axis parabolic (OAP) mirror 1540. The light reflected from OAP mirror 1540 is then directed to deformable mirror 1545. Light reflected from the deformable mirror 1545 is then split by beam splitter 1550. Light on one path from the beam splitter 1550 passes though lens 1555, where it is received by camera 1560. Light on another path from the beam splitter 1550 is received at a proximal end of a short (e.g., 0.5-10 mm) MMF 530′. Light exiting from the distal end of the MMF 530′ is focused by lens 540′ onto camera 550′. Although not shown, the sensed or detected speckle pattern is then provided as an input to the trained expert system 440′, which outputs predicted modal phase(s) and amplitude(s) of the light signal 1505.

Although step-index fibers were described, graded-index MMFs offer a promising avenue for extending the permissible fiber length. By reducing modal dispersion through more uniform group velocities, graded-index designs should preserve modal interference—and thus phase sensitivity—over longer propagation distances, potentially relaxing the tight length constraints imposed by broadband sources.

The MMF output contains sufficient information to recover, in principle, both the focal-plane image and the pupil-plane wavefront. Then, one could train separate CNNs—one for image reconstruction and another for phase retrieval—on the same dataset of MMF intensity patterns, yielding a dual-purpose sensor that simultaneously feeds science and wavefront-correction channels.

Beyond astronomy, our short-MMF+CNN sensor is well suited to free-space optical (FSO) communications—including quantum links—where atmospheric turbulence causes signal loss and errors. In FSO systems, adaptive optics must correct these distortions to preserve beam quality and protocol fidelity. A practical scheme could involve sending a “beacon” channel alongside the data channel along the same path. Since the beacon can be a narrowband and high-flux laser, the length and SNR requirements of the MMF-based wavefront sensor are easily met.

In summary, the combination of a very short MMF and fast CNN inversion offers a compelling alternative to existing pupil-plane and photonic-lantern wavefront sensors. Its compactness, low mass, low cost, and compatibility with integrated photonic platforms make it an attractive candidate for next-generation adaptive optics instruments in astronomy.

### § 4.4.4 Further Experiments

### § 4.4.4.3 Simulations

We Simulate the Light Propagation Through the Telescope and MMF Using the HCIPy package] (See, e.g., the document, E. H. Por, S. Y. Haffert, V. M. Radhakrishnan, D. S. Doelman, M. Van Kooten, and S. P. Bos, “High Contrast Imaging for Python (HCIPy): an open-source adaptive optics and coronagraph simulator,” In Adaptive Optics Systems VI, volume 10703 of Proc. SPIE, 2018 (incorporated herein by reference).), a comprehensive toolkit for high-contrast imaging simulations in Python.

In our simulations, the telescope is modeled as a circular aperture of diameter D=3.5 m and effective focal length of f=32.5 m, corresponding to an f/9.3 system with a telescope numerical aperture NAₜₑₗ≈D/(2f)≈0.05. At a wavelength λ=1 μm, the diffraction-limited Airy radius is r_{Airy}=1.22Δf/D≈6 μm. The multimode fiber (MMF) is represented as a step-index fiber with core radius r_{core}=25 μm, numerical aperture NA=0.1, and variable length L. These values were chosen to optimize coupling of low order aberrations: r_{core}>r_{Airy} ensures that the central lobe of the point-spread function is fully captured, and NA>NAₜₑₗ guarantees that the entire focal-plane beam cone enters the fiber.

The wavefront in the pupil plane is defined by setting the pupil function as the corresponding electric field. This wavefront represents the light reflected off the primary mirrors without any aberrations. To introduce atmospheric turbulence, we propagate the wavefront through the simulated single atmospheric layer. Next, we use the Fraunhofer Propagator to simulate the wavefront's propagation from the pupil to the focal plane.

The phase distribution at the pupil φ is expressed as a linear combination of a limited number of Zernike polynomials. The electric field at the pupil plane, for a given wavelength, is then Eₚᵤₚᵢₗ=Aperture·e^{iφ}, where “Aperture” is a field that has the value 1 inside the pupil and 0 outside it.

The wavefront in the focal plane is then propagated through the MMF. For that, it calculates the fiber LP modes and the corresponding propagation constant Bi. For the selected settings, the number of guided modes is 123. From the fiber mode basis, it calculates the transformation matrix between the basis of fiber modes and the original focal grid basis. Then, it projects the input electric field onto the fiber modes to obtain the excitation coefficients associated to each mode. At the fiber end, each guided mode has acquired a phase e_{iβz}. Finally, the output electric field is expressed in the focal-plane grid basis again.

To accurately simulate broadband light propagation through the multimode fiber, it is important to integrate over a sufficiently dense sampling of wavelengths. This is particularly important because the propagation constant of each mode depends strongly on the wavelength.

To determine an appropriate wavelength step size, we employed an empirical approach: we progressively decreased the spacing between adjacent wavelengths until the output speckle patterns from two consecutive wavelengths became visually indistinguishable. We found that direct visual comparison of output patterns was more sensitive to subtle changes than global metrics such as root mean squared error (RMSE).

As an example, for a 1 mm long fiber, convergence was visually achieved with a wavelength step of 0.05 nm.

We used two different sources: a 10 mW pigtailed laser diode with central wavelength of 1064 nm (model 23-799-RCD-05P-1064 nm from Edmund Optics), and a 150 W quartz halogen light source (Fiber-Lite DC-950), which is coupled into a single-mode fiber in order to clean the spatial mode. The broadband source is spectrally filtered by a bandpass filter with a central wavelength of 1 μm and a bandwidth of 10 nm.

A picture of the general experimental setup 1600 can be seen in FIG. 16. The setup 1600 includes source 1610, single-mode fiber 1620, collimating lens 1630, spectral filter 1640, mirrors 1650 and 1655, movable focusing lens 1660, multimode fiber 1670, imaging lens 1680, and CMOS imaging camera 1690. Light coming from the source 1610 is collimated using a fiber collimator package with a focal length of 11.17 mm and NA-0.25 (Thorlabs A280TM-C).

In the experiment, we used custom-cut multimode fibers 1670 (CeramOptec WF050125140) with a core radius r_{core}=50 μm and numerical aperture NA=0.22±0.2. Two fiber lengths were prepared-approximately 1 cm and 1 m—to probe the effects of modal delay. For each fiber, we optimized the coupling by adjusting the tip-tilt of two silver-coated mirrors 1650/1655 and precisely positioning the focusing lens L2. In all configurations, the coupling efficiency exceeded 90%.

The output of the MMF 1670 is then imaged by using an optical system formed by an achromatic lens 1680 with a focal length of 25 mm and a CMOS camera (Allied Vision Alvium 1800 U-501m NIR). The camera-lens optical system is optimized by looking at the speckles at the output of the MMF and try to make them the sharpest and clearest.

Positive and negative defocus were introduced by translating the in-coupling lens 1660 along the optical axis: a forward shift of Δz produces positive defocus, while a backward shift of the same magnitude produces negative defocus. This adjustment must be performed with care to avoid inadvertently adding odd-order aberrations such as tip/tilt, which could be detected directly in the focal-plane image. To ensure the beam remained perpendicular to both the lens and the fiber end face, we optimized alignment by simultaneously monitoring the MMF output intensity pattern and maximizing the total coupling efficiency.

### § 4.4.4.3 Phase Reconstruction Via Deep Learning

Convolutional Neural Networks (CNNs) are particularly well suited for solving imaging problems, as they are designed to extract spatial features from images through successive layers of convolution and pooling. In the context of multimode fiber (MMF) speckle patterns, CNNs offer a natural framework for inferring input phase information from complex output intensity images. (See, e.g., the document, Ayan Sinha, Justin Lee, Shuai Li, and George Barbastathis, “Lensless computational imaging through deep learning,” Optica, 4(9):1117-1125, 2017 (incorporated herein by reference).) Accordingly, CNNs have been widely adopted in MMF-related applications in imaging and optical communications, where they are used to reconstruct or classify images transmitted through the fiber. (See, e.g., the document, Navid Borhani, Eirini Kakkava, Christophe Moser, and Demetri Psaltis, “Learning to see through multimode fibers,” Optica, 5(8):960, August 2018 (incorporated herein by reference), the document, Babak Rahmani, Damien Loterie, Georgia Konstantinou, Demetri Psaltis, and Christophe Moser, “Multimode optical fiber transmission with a deep learning network,” Light: Science & Applications, 7(1):69, October 2018 (incorporated herein by reference), and the document, Changyan Zhu, Eng Aik Chan, You Wang, Weina Peng, Ruixiang Guo, Baile Zhang, Cesare Soci, and Yidong Chong, “Image reconstruction through a multimode fiber with a simple neural network architecture,” Scientific Reports, 11(1):896, January 2021 (incorporated herein by reference).) Most of these works rely on popular architectures such as VGG (See, e.g., the document, Karen Simonyan and Andrew Zisserman, “Very deep convolutional networks for largescale image recognition,” arXiv preprint arXiv: 1409.1556, 2014 (incorporated herein by reference).) and U-Net (See, e.g., the document, Olaf Ronneberger, Philipp Fischer, and Thomas Brox, “U-net: Convolutional networks for biomedical image segmentation,” In Medical image computing and computer assisted intervention-MICCAI 2015: 18th international conference, Munich, Germany, Oct. 5-9, 2015, proceedings, part III 18, pages 234-241. Springer, 2015 (incorporated herein by reference).) due to their proven performance in tasks involving either classification or image-to-image translation. However, alternative approaches have also been explored. (See, e.g., the document, Changyan Zhu, Eng Aik Chan, You Wang, Weina Peng, Ruixiang Guo, Baile Zhang, Cesare Soci, and Yidong Chong, “Image reconstruction through a multimode fiber with a simple neural network architecture,” Scientific Reports, 11(1):896, January 2021 (incorporated herein by reference), and the document, Piergiorgio Caramazza, Ois'n Moran, Roderick Murray-Smith, and Daniele Faccio, “Transmission of natural scene images through a multimode fibre,” Nature Communications, 10(1):2029 May 2019 (incorporated herein by reference).)

In some examples described in the present description, a supervised deep learning approach was used to reconstruct the phase in the focal plane from the intensity images, at the output of the MMF, for a broadband source at 1 μm with 10 nm (or 100 nm) bandwidth. Two datasets were generated, using the simulations described above, with the solely difference that in one dataset the OPD was limited to the range±λ/2 to prevent phase wrap. In both cases, the atmosphere was randomly sampled by varying the Fried parameter (0.6, 0.9, 1.5, 2, and 2.2 m). Each dataset consisted of 120,000 samples, split for training and validation (80/20%). In addition, 10000 samples were generated for testing the network performance based on the different atmospheric conditions.

A simple convolutional neural network architecture was defined using three layers followed by their corresponding activation function. Max-pooling was applied to each of these layers for downsampling. (See, e.g., the document, Yann LeCun, L'eon Bottou, Yoshua Bengio, and Patrick Haffner, “Gradient-based learning applied to document recognition,” Proceedings of the IEEE, 86(11):2278-2324, 1998 (incorporated herein by reference), and the document, Alex Krizhevsky, Ilya Sutskever, and Geoffrey E Hinton, “Imagenet classification with deep convolutional neural networks,” Advances in neural information processing systems, 25, 2012 (incorporated herein by reference).) In the output, a fully connected layer was used to extract the coefficients of the 122 modes that propagate through the MMF. The network was optimized by randomized search over 10000 samples (training set). (See, e.g., the document, James Bergstra and Yoshua Bengio, “Random search for hyper parameter optimization,” Journal of machine learning research, 13(2), 2012 (incorporated herein by reference).) This process explores various hyperparameters, including the impact of the input and output channels of each layer, the corresponding activation functions, and fine-tune the best optimizer, learning rate, batch size, and number of epochs. The final network architecture, for the non-OPD-limited and OPD-limited dataset, employed 16, 64 and 32 output/input channels for the convolutional layers. A hyperbolic tangent (tanh) was used as activation function for the first two layers whereas a Rectified Linear Unit (ReLU) was employed for the last one. The optimizer selected was a SGD with a learning rate of 0.01. A batch size of 32 was used to train the network for 50 epochs.

Furthermore, to investigate the impact of dataset size, the network was trained using half and the full set of samples, with an 80/20% split for training and validation in both cases.

The Root Mean Square Error (RMSE) between the predictions and the original values measured the performance of the trained models. Subsequently, from the 122 coefficients extracted, images were reconstructed to compare predicted versus original OPD. In this case, the similarity between images was quantified by the rms (pixelwise).

### § 4.5 CONCLUSIONS

We describe a simpler and more compact approach than traditional wavefront sensors: we couple the distorted focal plane field directly into a single, very short multimode fiber (MMF) and image the resulting interference pattern on a camera. Under the weak-guidance approximation, the input field can be decomposed into a set of guided fiber modes (LP modes), each of which accumulates a different phase constant. When the fiber is sufficiently short (typically 0.1-1 cm long), the differences in group delay between modes remain much smaller than the coherence time of a broadband source (˜10-100 nm bandwidth), so the interference fringes are preserved rather than averaged out. The resulting output pattern is therefore highly sensitive to both the amplitudes and relative phases of the excited modes—and hence to the full complex input wavefront—making it possible to reconstruct the wavefront purely from the measured intensity.

Recovering the pupil-plane phase from the output intensity pattern of the MMF is a nonlinear problem, which we solve by training a convolutional neural network (CNN) on pairs of known wavefronts and MMF output images. (See, e.g., the document, Ayan Sinha, Justin Lee, Shuai Li, and George Barbastathis, “Lensless computational imaging through deep learning,” Optica, 4(9):1117-1125, 2017 (incorporated herein by reference).) Once trained, the CNN delivers wavefront reconstructions on millisecond timescales, fast enough to follow atmospheric fluctuations. Furthermore, CNNs for related MMF applications have demonstrated robustness under variable external conditions (See, e.g., the document, Zhong Wen, Zhenyu Dong, Qilin Deng, Chenlei Pang, Clemens F. Kaminski, Xiaorong Xu, Huihui Yan, Liqiang Wang, Songguo Liu, Jianbin Tang, Wei Chen, Xu Liu, and Qing Yang, “Single multimode fibre for in vivo light-field-encoded endoscopic imaging,” Nature Photonics, 17 (8): 679-687, August 2023 (incorporated herein by reference), and the document, Abdullah Abdulaziz, Simon Peter Mekhail, Yoann Altmann, Miles J. Padgett, and Stephen McLaughlin, “Robust real-time imaging through flexible multimode fibers,” Scientific Reports, 13(1):11371, July 2023 (incorporated herein by reference).), underscoring the feasibility of our approach for ground-based astronomical applications.

Although multimode fibers (MMFs) have been proposed for bioimaging and optical communications (See, e.g., the document, Navid Borhani, Eirini Kakkava, Christophe Moser, and Demetri Psaltis, “Learning to see through multimode fibers,” Optica, 5(8):960, August 2018 (incorporated herein by reference), the document, Babak Rahmani, Damien Loterie, Georgia Konstantinou, Demetri Psaltis, and Christophe Moser, “Multimode optical fiber transmission with a deep learning network,” Light: Science & Applications, 7(1):69, October 2018 (incorporated herein by reference), the document, Changyan Zhu, Eng Aik Chan, You Wang, Weina Peng, Ruixiang Guo, Baile Zhang, Cesare Soci, and Yidong Chong, “Image reconstruction through a multimode fiber with a simple neural network architecture,” Scientific Reports, 11(1):896, January 2021 (incorporated herein by reference), the document, Jian Wang, Guangchao Zhong, Daixuan Wu, Sitong Huang, Zhi-Chao Luo, and Yuecheng Shen, “Multimode fiber-based greyscale image projector enabled by neural networks with high generalization ability,” Optics Express, 31(3):4839 January 2023 (incorporated herein by reference), and the document, Piergiorgio Caramazza, Ois'in Moran, Roderick Murray-Smith, and Daniele Faccio, “Transmission of natural scene images through a multimode fibre,” Nature Communications, 10(1):2029 May 2019 (incorporated herein by reference).), their adaptation to astronomical wavefront sensing entails three principal challenges. First, unlike laboratory settings where a narrowband laser or reference beam can be employed, astronomical observations must rely on uncontrolled, broadband starlight. Second, the use of very narrow spectral filters to enhance coherence length markedly reduces photon throughput—thereby degrading the signal-to noise ratio—and introduces 2π phase-wrapping ambiguities that constrain the measurable optical path difference (OPD). Third, standard-length MMFs are intrinsically sensitive to mechanical vibrations and thermal drifts in observatory environments, leading to variations in the fiber's transmission matrix and necessitating frequent recalibration.

The present description demonstrates that very short MMFs (0.1 cm long) maintain modal interference under a˜10-100 nm bandwidth, thus avoiding severe phase-wrap limitations while maximizing photon efficiency. We demonstrated that it breaks the ±sign ambiguity for even phases at the pupil both in simulations and in the lab. Their compact length makes it easier to implement mechanical and thermal stabilization, rendering the fiber far less sensitive to environmental perturbations. Moreover, we showed that a deep neural network can recover the input wavefront from the MMF's output intensity patterns on millisecond timescales, satisfying the real-time requirements of astronomical wavefront sensing.

An example machine described here may perform one or more of the processes described, and/or store information used and/or generated by such processes. The exemplary machine includes one or more processors, one or more input/output interface units, one or more storage devices, and one or more system buses and/or networks for facilitating the communication of information among the coupled elements. One or more input devices and one or more output devices may be coupled with the one or more input/output interfaces. The one or more processors may execute machine executable instructions (e.g., C or C++ running on the Linux operating system widely available from a number of vendors) to perform one or more aspects of the present description. At least a portion of the machine executable instructions may be stored (temporarily or more permanently) on the one or more storage devices and/or may be received from an external source via one or more input interface units. The machine executable instructions may be stored as various software modules, each module performing one or more operations. Functional software modules are examples of components of the present description.

In some embodiments consistent with the present description, the processors may be one or more microprocessors and/or ASICs. The bus may include a system bus and/or data links. The storage devices may include system memory, such as read only memory (“ROM”) and/or random access memory (“RAM”). The storage devices may also include a hard disk drive for reading from and writing to a hard disk, a magnetic disk drive for reading from or writing to a (e.g., removable) magnetic disk, an optical disk drive for reading from or writing to a removable (magneto-) optical disk such as a compact disk or other (magneto-) optical media, or solid-state non-volatile storage.

Some example embodiments consistent with the present description may also be provided as a machine-readable medium for storing the machine-executable instructions. The machine readable medium may be non-transitory and may include, but is not limited to, flash memory, optical disks, CD-ROMs, DVD ROMs, RAMS, EPROMS, EEPROMs, magnetic or optical cards or any other type of machine-readable media suitable for storing electronic instructions. For example, example embodiments consistent with the present description may be downloaded as a computer program which may be transferred from a remote computer (e.g., a server) to a requesting computer (e.g., a client) by way of a communication link (e.g., a modem or network connection) and stored on a non-transitory storage medium. The machine-readable medium may also be referred to as a processor-readable medium.

Example embodiments consistent with the present description (or components or modules thereof) might be implemented in hardware, such as one or more field programmable gate arrays (“FPGA”s), one or more integrated circuits such as ASICs, etc. Alternatively, or in addition, embodiments consistent with the present description (or components or modules thereof) might be implemented as stored program instructions executed by a processor.

What is claimed is:

1. A method for light/wavefront sensing, the method comprising:
a) receiving a light having a spectral range of interest;
b) focusing the light received onto a first surface of a multimode transmission medium;
c) imaging a speckle pattern from light exiting a second surface of the multimode transmission medium to generate a spectral pattern image;
d) providing the speckle pattern as input to an expert system that has been trained to predict at least one of (A) phase(s) and/or (B) amplitude(s) of light received from a speckle pattern; and
e) generating, using the expert system, at least one of (A) phase(s) and/or (B) amplitude(s) of the light received and focused onto the first surface of the multimode transmission medium.

2. The method of claim 1, wherein the multimode transmission medium is a multimode fiber.

3. The method of claim 2, wherein a length of the multimode fiber is 1 cm or less.

4. The method of claim 2, wherein a length of the multimode fiber is 0.1 cm-1.0 cm.

5. The method of claim 2, wherein a length of the multimode fiber is selected to preserve modal interference across a spectral range of interest in the light received and focused onto the first surface of the multimode transmission medium.

6. The method of claim 2, wherein a maximum length (L) of the multimode fiber is defined by:
$${L}_{∼}^{<} \frac{{λ}^{2}}{Δλ \cdot Δ {n}_{g}}$$
wherein λ is a central wavelength of the light received and focused onto the first surface of the multimode transmission medium,
wherein Δλ is a spectral bandwidth of interest of the light received and focused onto the first surface of the multimode transmission medium, and
wherein Δn_{g} is a variation in a group index across modes supported by the multimode fiber.

7. Apparatus for light/wavefront sensing, the apparatus comprising:
a) a multimode transmission medium;
b) a first optical system configured to receive a light having a spectral range of interest, and focus the light received onto a first surface of the multimode transmission medium;
c) an imaging device;
d) a second optical system configured to focus a speckle pattern from light exiting a second surface of the multimode transmission medium onto an imaging plane of the imaging device; and
e) an expert system that has been trained to predict at least one of (A) phase(s) and/or (B) amplitude(s) of light received from a speckle pattern, the expert system configured to
1) receive a speckle pattern image from the imaging device, and
2) generate at least one of (A) phase(s) and/or (B) amplitude(s) of the light received and focused onto the first surface of the multimode transmission medium.

8. The apparatus of claim 7, wherein the multimode transmission medium is a multimode fiber.

9. The apparatus of claim 8, wherein a length of the multimode fiber is 1 cm or less.

10. The apparatus of claim 8, wherein a length of the multimode fiber is 0.1 cm-1.0 cm.

11. The apparatus of claim 8, wherein a length of the multimode fiber is selected to preserve modal interference across a spectral range of interest in the light received and focused onto the first surface of the multimode transmission medium.

12. The apparatus of claim 8, wherein a maximum length (L) of the multimode fiber is defined by:
$${L}_{∼}^{<} \frac{{λ}^{2}}{Δλ \cdot Δ {n}_{g}}$$
wherein λ is a central wavelength of the light received and focused onto the first surface of the multimode transmission medium,
wherein Δλ is a spectral bandwidth of interest of the light received and focused onto the first surface of the multimode transmission medium, and
wherein Δn_{g} is a variation in a group index across modes supported by the multimode fiber.
